(19) United States
(12) Patent Application Publication
(10) Pub. No.: US 2009/0239691 A1
(43) Pub. Date: Sep. 24, 2009

(54) SILENT CHAIN

(75) Inventor: Minoru Komada, Osaka (JP)

Correspondence Address: HOWSON & HOWSON LLP, 501 OFFICE CENTER DRIVE, SUITE 210, FORT WASHINGTON, PA, 19034, US

(73) Assignee: Tsubakimoto Chain Co.,, Osaka (JP)

(21) Appl. No.: 12/403,706

(22) Filed: Mar. 13, 2009

(30) Foreign Application Priority Data
Mar. 24, 2008 (JP) 2008-075571

(51) Int. Cl. F16H 57/05

(52) U.S. Cl. 474/91

(57) ABSTRACT

The connecting pins of a chain protrude laterally from the chain, and are bent toward the inside of the loop formed by the chain so that they can stir lubricating oil in an oil bath, preventing localized heating and oil deterioration, and so that they can splash oil toward the central part of the chain for enhanced lubrication.

### CROSS-REFERENCE TO RELATED APPLICATION

This application claims priority on the basis of Japanese patent application 2008-075571, filed Mar. 24, 2008. The disclosure of Japanese application 2008-075571 is hereby incorporated by reference.

### FIELD OF THE INVENTION

The invention relates to a chain, and more specifically to a chain having a structure enhancing its torque transmission capability and its service life.

### BACKGROUND OF THE INVENTION

Large width silent chains, as shown schematically in FIG. 9, have come into increasing use for high torque transmission applications such as in the transmissions of four wheel drive vehicles and hybrid vehicles, and in the transmission of power from an engine to a transmission or the like. An example of such a chain is described in U.S. Pat. No. 6,432,011.

The silent chain 400, shown in FIG. 9, is in mesh with two sprockets SP. The chain transmits of power from one sprocket to the other, and the chain 400 is cooled by immersion of a part of one of the sprockets SP in a lubricating oil bath.

In the operation of the chain, heat is generated by engagement of the chain with the sprockets, and by friction between relatively moving chain components, for example, between a connecting pin and an inner link plate, or between link plates. Because of the large width of the chain, frictional heat is not readily dissipated, and the resulting increase in the temperature of the chain causes elongation of the chain. Elongation of the chain, in turn, can impair the engagement of the chain with the sprockets SP, and reduce the amount of torque that the chain is capable of transmitting.

When the silent chain 400 is cooled by immersion in an oil bath as mentioned above, the lubricating oil in the vicinity of the silent chain contributes to lubrication and heat dissipation. However, the lubricating oil usually has a high viscosity, so that natural convection due to temperature differences at different levels in the oil bath does not take place to a sufficient extent. Therefore, the temperature of the lubricating oil near the chain is locally increased, and the lubricating oil deteriorates. As a result, the service life of the chain can be impaired.

Because of the high viscosity of the lubricating oil, it also takes time for the oil to reach the part of the inner circumferential side of the chain loop that is engaged with the sprocket and located centrally in the direction of the width of the chain. Particularly at higher operating speeds, the supply of the lubricating oil to this part of the chain becomes inadequate, the temperature of the central part of the chain increases, and thermal expansion occurs, causing the chain to wear. As the result, the central portion of the chain does not properly engage the sprockets SP, the load sustained by the outer parts of the chain increases, power transmission becomes inefficient, and wear elongation of the chain is accelerated. In some cases, tooth jumping can occur, and in the worst case, breakage of the chain can occur.

The invention seeks to overcome the above-described technical problems, and to provide a chain in which heat dissipation is improved, high transmission torque can be maintained, and a long service life is realized. An object of the invention is to suppress deterioration of lubricating oil due to localized high temperature conditions, and to provide for a smooth supply of lubricating oil to the central portion of the chain on the inner circumferential side, so that tooth jumping is suppressed.

### SUMMARY OF THE INVENTION

The chain according to the invention is an elongated chain comprising inner and outer links connected in alternating, overlapping relationship by connecting pins to form a closed loop. The connecting pins have portions protruding laterally from the chain by a distance at least as great as the greatest thickness of a connecting pin, and the protruding portions of at least some of the connecting pins are bent toward the inside of the closed loop.

In the case of a silent chain in accordance with the invention, the chain is an elongated silent chain comprising inner plates each having a pair of teeth, a pair of pin holes, and a back surface, guide plates, and connecting pins. The inner plates are alternately arranged in guide rows and non-guide rows extending transverse to the direction of elongation of the chain. The plates of the non-guide rows are interleaved with the plates of the guide rows, and each guide row also includes guide plates at its opposite ends at the outermost sides of the chain. Each guide plate has a pair of pin holes, and a surface facing outwardly toward a side of the chain. Connecting pins extend through pin holes in the interleaved plates, and are secured to pin holes in the guide plates, whereby the guide rows and non-guide rows are connected in articulating relationship in a closed loop. The connecting pins have portions protruding from the outer surfaces of the guide plates by a distance at least as great as the greatest thickness of a connecting pin, and the protruding portions of at least some of said connecting pins are bent toward the inside of the closed loop.

The protruding portions of the connecting pins can all be of the same length and can all be bent at the same angle. However, on each side of the chain, the lengths of the protruding portions of some of the pins can differ from the lengths of the protruding portions of other pins on the same side of the chain. Similarly, on each side of the chain, the angles at which the protruding portions of some of the pins are bent can differ from the angles at which the protruding portions of other pins on the same side of the chain are bent.

Heat generated by friction is efficiently released to the surrounding air or to the lubricating oil from the protruding portions of the connecting pins. Therefore, thermal expansion of the chain is suppressed, and impairment of engagement of the chain with its sprockets is suppressed so that high torque transmission capability can be maintained.

Furthermore, since the protruding portions of the connecting pins can stir lubricating oil in an oil bath, local temperature increases in the lubricating oil in the vicinity of the silent chain are avoided, so that deterioration of the lubricating oil is suppressed. Thus, a long service life of the silent chain can be attained.

Furthermore, since the protruding portions of the connecting pins are bent toward the inner circumferential side of the chain loop, as the chain enters the lubricating oil bath, splashing of the lubricating oil is generated. The splashed lubricating oil is supplied to the central portion of the chain in the chain width direction and on the side of the chain which faces the inside of the loop and engages the sprocket. Thus, satisfactory engagement between the chain and the sprocket is maintained over a long period of time, and tooth jumping and breakage of the chain are suppressed.

Where the lengths of some protruding portions of some of the connecting pins on each side of the chain differ from the lengths of other protruding portions on the same side of the chain, i.e., when the protruding lengths are non-uniform, the stirring of the lubricating oil changes as the chain moves. Changing the stirring condition continuously further suppresses deterioration of the lubricating oil and increases the service long life of the chain.

Where the bending angles of the protruding portions of the connecting pins on each side of the chain differ from the bending angles of other protruding portions on the same side of the chain, i.e., when the bending angles are non-uniform, the splashing of lubricating oil changes as the chain moves, and lubricating oil is more uniformly supplied to the inner circumferential side of the chain. Thus, satisfactory engagement between the chain and the sprocket can be maintained for an even longer period of time, and the chance of tooth jumping and breakage of the chain can be further reduced.

### BRIEF DESCRIPTION OF THE DRAWINGS

FIG. 1 is a schematic perspective view of a silent chain according to the invention;

FIG. 2 is a perspective view showing details of a part of the silent chain of FIG. 1;

FIG. 3 is a schematic view showing the silent chain operated in an oil bath;

FIG. 4 is an enlarged schematic view of the part of the mechanism of FIG. 3 designated by reference number IV;

FIG. 5 is schematic view illustrating the splashing of lubricating oil;

FIG. 6 is a schematic view showing the mechanism of FIG. 4, viewed in the direction indicated by arrow VI in FIG. 4;

FIG. 7 is a perspective view of a part of a silent chain in accordance with a second embodiment of the invention;

FIG. 8 is a perspective view of a part of a silent chain in accordance with a third embodiment of the invention; and

FIG. 9 is a schematic perspective view of a conventional silent chain.

### DETAILED DESCRIPTION OF THE PREFERRED EMBODIMENTS

The inwardly bent protruding connecting pins of the chain according to the invention improve the release of heat, maintain high torque transmission, improve the service life of the chain suppress deterioration of lubricating oil due to local temperature increases, and, by more smoothly supplying lubricating oil to the central portion of the chain on the side facing the inside of the loop formed by the chain, reduce the likelihood of tooth jumping and breakage of the chain. As will be explained below, the chain in accordance with the invention can be realized in any of various embodiments.

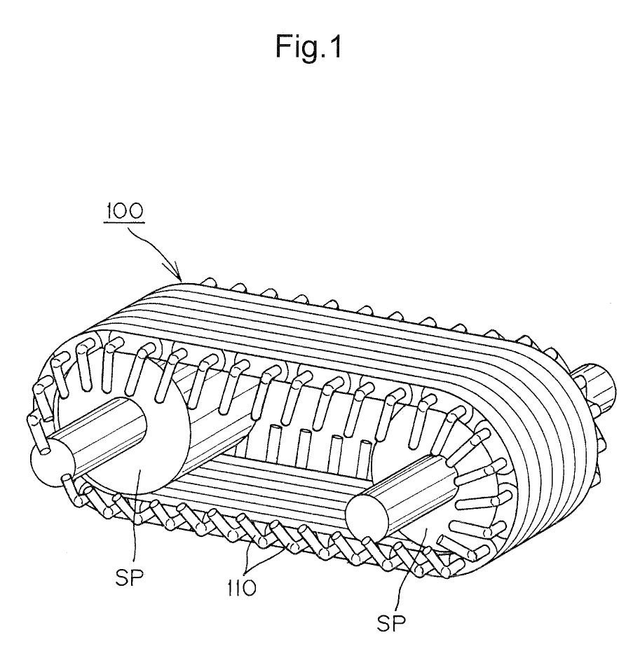

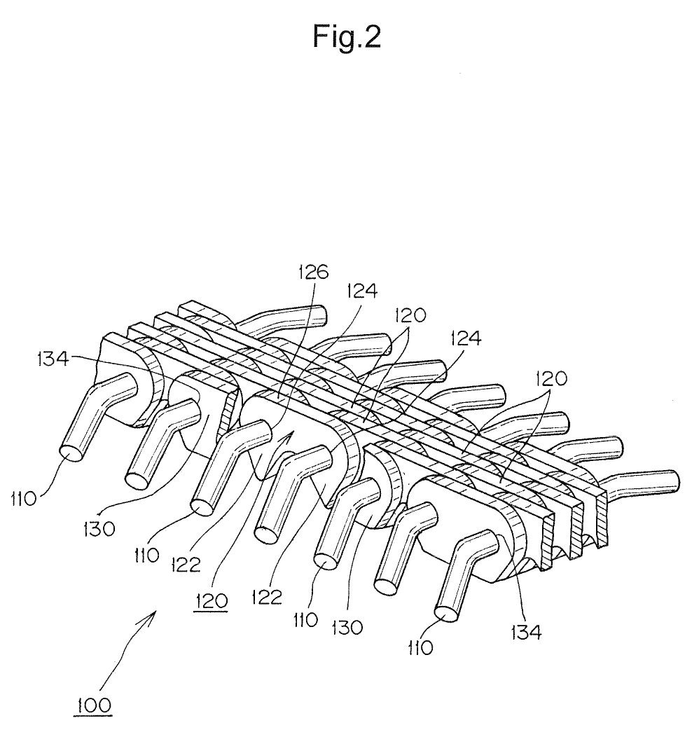

As shown in FIG. 1, a silent chain 100 according to a first embodiment of the invention, is wrapped around two sprockets SP. As shown in FIG. 2, the chain comprises a number of inner plates 120, each having a pair of teeth 122, a pair of pin holes 124, and a back surface 126. The inner plates are arranged in alternating, interleaved, guide rows and non-guide rows. Guide plates 130, each having pin holes 134, are arranged at opposite ends of each guide row so that guide plates are provided along both sides of the chain. Connecting pins 110 are inserted through pin holes 124 of the inner link plates 120 and secured to pin holes 134 of the guide plates 130, so that the guide rows and non-guide rows are connected particularly, to provide a chain in the form of a closed loop, with the teeth of the inner link plates of the chain protruding toward the inside of the loop.

As shown in FIGS. 1 and 2, the connecting pins 110 protrude from outer surfaces of the guide plates 130, preferably by a distance at least as great as the maximum thickness of any connecting pin in the chain. The value of the maximum thickness of a connecting pin 110 corresponds to the diameter of the pin in a case of a pin having a circular cross-section.

The protruding portions of the connecting pins 110 are bent toward the inside of the loop formed by the silent chain 100. By the term “bent toward the inside of the loop” is meant that the protruding portions of the pins are bent toward the inside of a lateral projection of the loop formed by the chain.

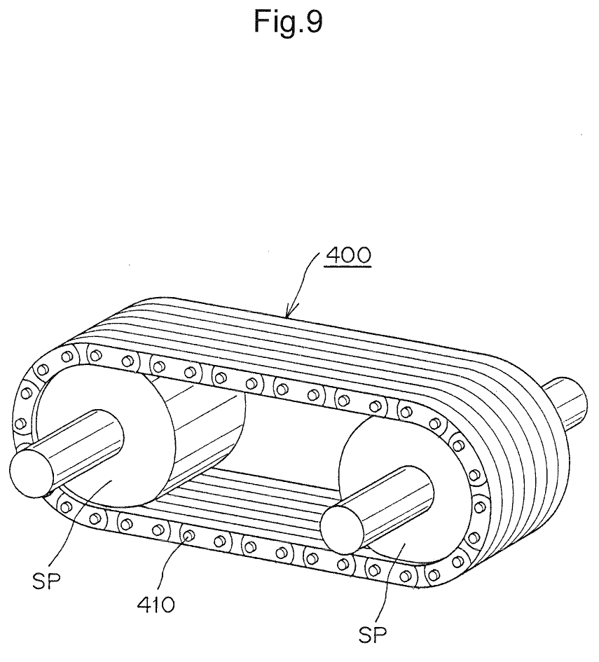

Even in the case of a conventional silent chain as shown in FIG. 9, the connecting pins protruding slightly from the guide plates. Moreover, in the process of press-fitting the connecting pins to the guide plates, the protruding portions of the pins can be bent. In such a case, however, the connecting pins no appreciable effect in stirring or splashing the lubricating oil. On the other hand, if the connecting pins protrude by a distance at least as great as their thickness, and are bent inward, the heat release effect, oil stirring effect, and oil splashing effect can be realized. Thus, the extent of protrusion of the pins and the fact that they are bent inward differentiates the structure of the invention from that of the conventional silent chain.

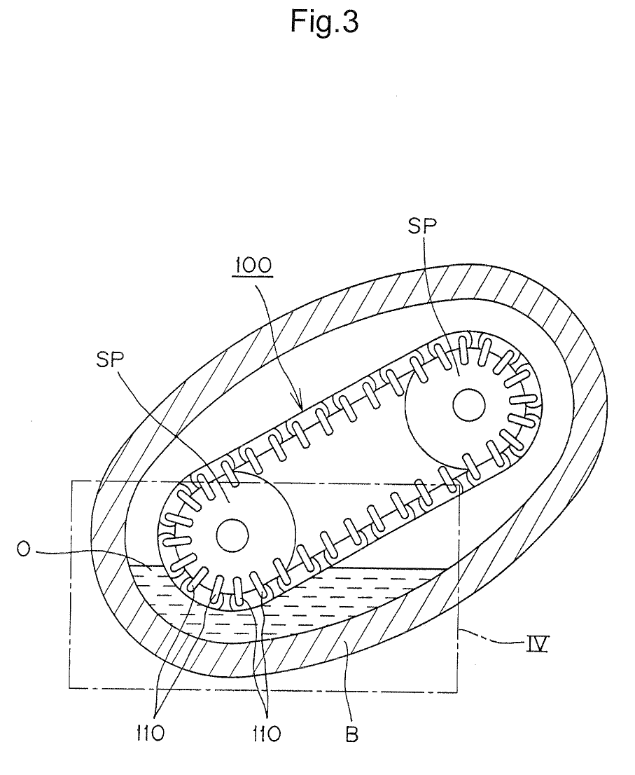

FIG. 3 shows a silent chain 100 wrapped around two sprockets SP, one sprocket being at a height above that of the other sprocket. A part of the silent chain 100, which is engaged with the lower sprocket SP is immersed into lubricating oil O reserved in an oil bath B. The heat generated by friction between components of the silent chain 100 is efficiently released through the protruding portions of the connecting pins 110 to the lubricating oil o and to the atmosphere above the surface of the oil, which contains a mist of oil. At the same time, the lubricating oil O in the oil bath B is stirred by the motion of the protruding portions of the connecting pins.

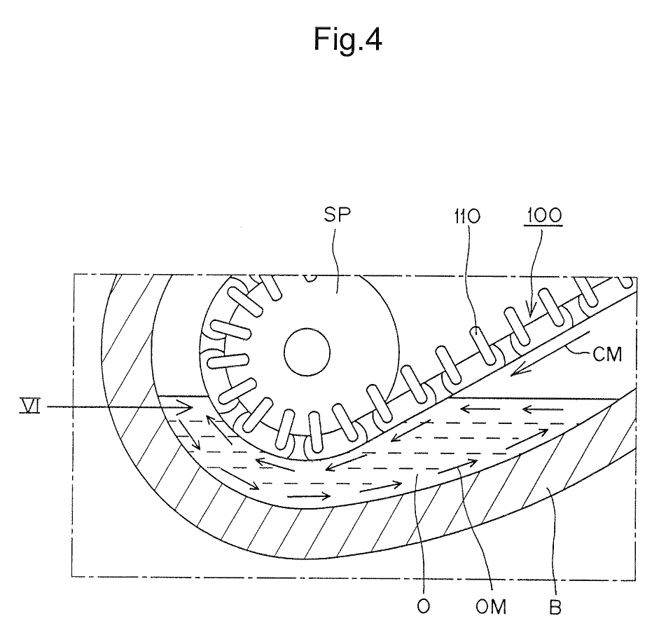

As shown in FIG. 4, when the silent chain 100 advances toward the lower sprocket SP in the direction CM, and moves around the lower sprocket, the protruding portions of the connecting pins generate a circulating movement of the oil in the oil bath in a path indicated by arrows OM. This circulating movement of oil allows the oil heated by the chain in the upper part of the oil bath to mix with cooler lubricating oil in the vicinity of the bottom of the oil bath B, thereby suppressing a local temperature rise in the oil in the vicinity of the silent chain. Thus, deterioration of the lubricating oil is suppressed.

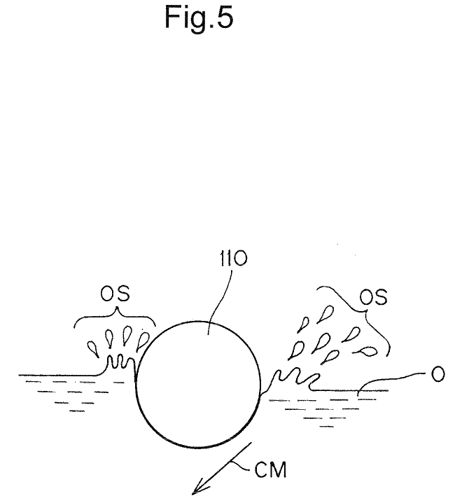

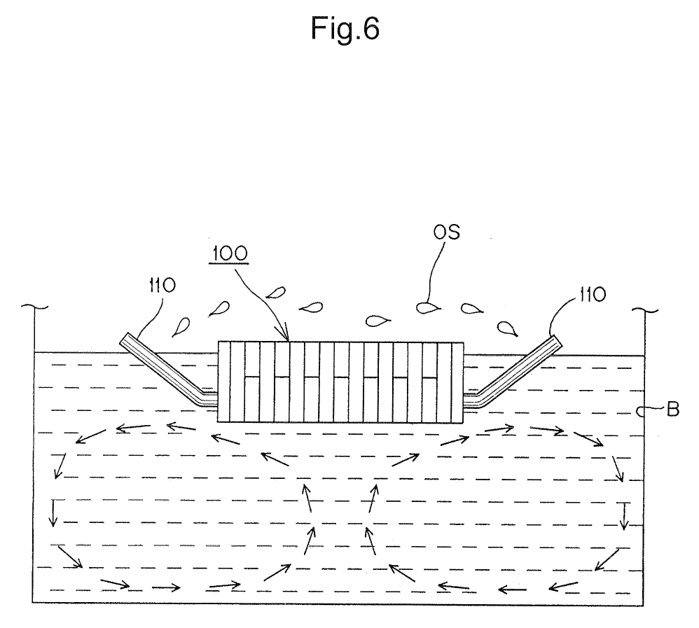

The manner in which the protruding pins splash lubricating oil is illustrated in FIGS. 5 and 6. FIG. 5 shows a connecting pin 110 entering the lubricating oil bath. Droplets OS of lubricating oil are generated on both sides of the pin 110 relative to the direction CM in which the connecting pin 110 advances. Because the connecting pin 110 is bent toward the inside of the loop formed by the chain, as shown in FIG. 6, when the connecting pins enter the oil bath, oil is splashed toward the central part of the chain with reference to the direction of the width of the chain at a location on the chain that is approaching the partially submerged sprocket. Therefore, lubricating oil O is smoothly supplied to the central part of the silent chain in the chain width direction, on the side of the chain facing the sprocket.

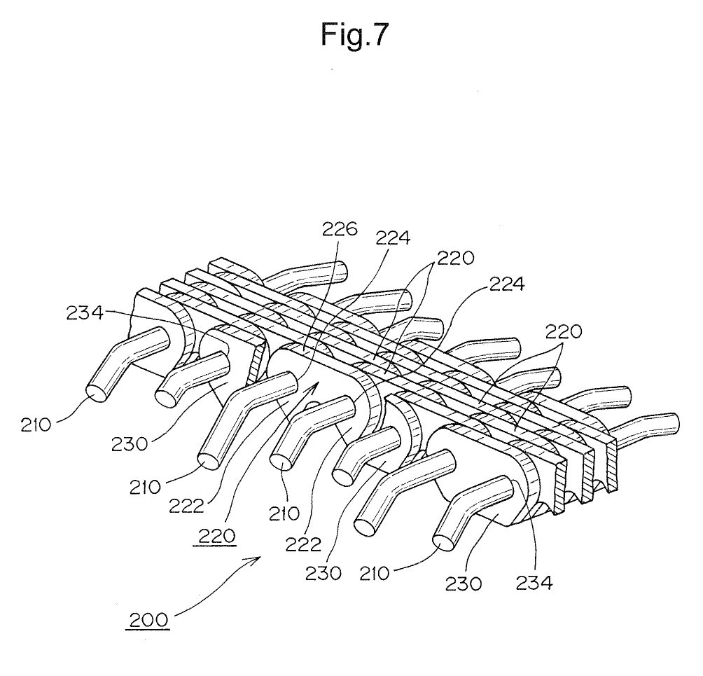

As shown in FIG. 7, in a second embodiment of the invention, a silent chain 200 has the same basic configuration as the silent chain 100. Parts are designated by reference numbers that exceed the reference numbers of corresponding parts in FIG. 2 by one hundred.

The silent chain 200 in FIG. 7 differs from the silent chain 100 in FIG. 2 only in that the protruding parts of the connecting pins 210, have non-uniform lengths. That is, the lengths of some protruding portions of some of the connecting pins on each side of the chain differ from the lengths of other protruding portions on the same side of the chain. As a result, the stirring effect on lubricating oil in the oil bath is changed, so that the lubricating oil that is heated near the surface of the oil bath is more effectively mixed with oil from the bottom of the oil bath. As a result a local temperature rise in the lubricating oil in the vicinity of the silent chain 200 is more effectively suppressed, and deterioration of the lubricating oil is further suppressed.

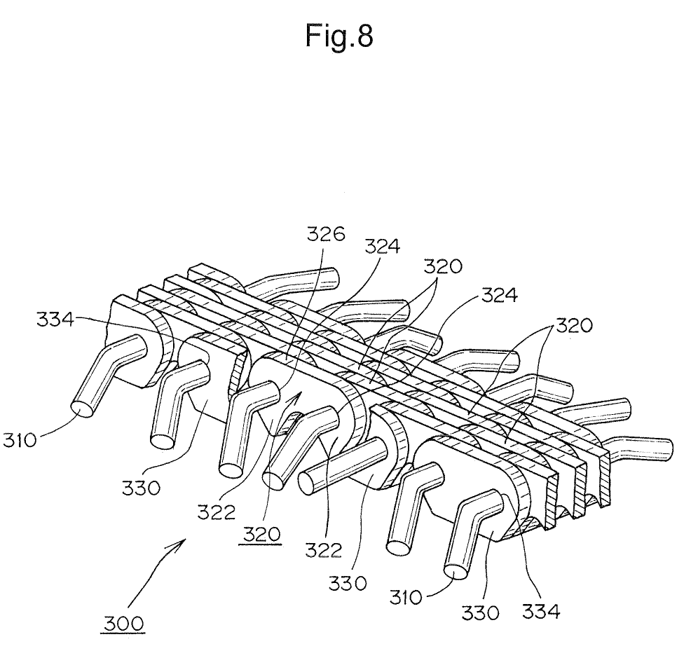

As shown in FIG. 8, in a third embodiment of the invention, a silent chain 300 has the same basic configuration as the silent chain 100. Parts are designated by reference numbers that exceed the reference numbers of corresponding parts in FIG. 2 by two hundred.

The silent chain 800 in FIG. 8 differs from the silent chain 100 in FIG. 2 only in that the protruding parts of the connecting pins 210, have non-uniform bending angles. That is, on each side of the chain, the angles at which the protruding portions of some of the pins are bent differ from the angles at which the protruding portions of other pins on the same side of the chain are bent. As a result, lubricating oil is more uniformly splashed toward the part of the chain at an intermediate location in the widthwise direction on the part of the chain approaching facing relationship with the partially submerged sprocket. Thus, tooth jumping and breakage of the chain can be suppressed, and satisfactory engagement between the chain and the sprocket can be maintained for a long period of time.

Although in the above-described embodiments the connecting pins have a circular cross-sectional shape, the connecting pins can have different shapes. For example the pins can be rocker pins, each consisting of two elements one of which rocks against the other. In the case of a rocker pin, it is preferable that one of the elements of the rocker pin be longer than the other, and that the protruding parts that generate splashing and stirring of the lubricating oil be parts of the longer element.

Whereas in the above-described embodiments, the connecting pins protrude to both the right and left sides of the chain, the protruding portions of the connecting pins can be provided on only one side. This configuration is advantageous where protrusion from both sides would interfere with adjacent machine components.

Furthermore, although the invention is described with reference to a silent chain the advantages of the invention can be realized in a multi-roller chain having a similar structure.

The invention has industrial applicability in camshaft driving in an automobile engine or the like, as well as in many kinds of machines such as conveyors, and in motive power transmissions.

What is claimed is:

1. An elongated chain comprising inner and outer links connected in alternating, overlapping relationship by connecting pins to form a closed loop, wherein said connecting pins have portions protruding laterally from the chain by a distance at least as great as the greatest thickness of a connecting pin, and wherein the protruding portions of at least some of said connecting pins are bent toward the inside of said closed loop.

2. A chain according to claim 1, in which, on each side of the chain the lengths of the protruding portions of some of the pins differ from the lengths of the protruding portions of other pins on the same side of the chain.

3. A chain according to claim 1, in which, on each side of the chain, the angles at which the protruding portions of some of the pins are bent differ from the angles at which the protruding portions of other pins on the same side of the chain are bent.

4. A chain according to claim 3, in which, on each side of the chain the lengths of the protruding portions of some of the pins differ from the lengths of the protruding portions of other pins on the same side of the chain.

5. A chain according to claim 1, in which the protruding portions of all of said connecting pins are bent toward the inside of said closed loop.

6. An elongated silent chain comprising inner plates each having a pair of teeth, a pair of pin holes, and a back surface, and guide plates, the inner plates being alternately arranged in guide rows and non-guide rows extending transverse to the direction of elongation of the chain, the plates of the non-guide rows being interleaved with the plates of the guide rows, and each guide row also including guide plates at its opposite ends at the outermost sides of the chain, each guide plate having a pair of pin holes and a surface facing outwardly toward a side of the chain, and connecting pins extending through pin holes in the interleaved plates and secured to pin holes in the guide plates whereby the guide rows and non-guide rows are connected in articulating relationship in a closed loop, and wherein said connecting pins have portions protruding from the outer surfaces of the guide plates by a distance at least as great as the greatest thickness of a connecting pin, and wherein the protruding portions of at least some of said connecting pins are bent toward the inside of said closed loop.

7. A silent chain according to claim 6, in which, on each side of the chain the lengths of the protruding portions of some of the pins differ from the lengths of the protruding portions of other pins on the same side of the chain.

8. A silent chain according to claim 6, in which, on each side of the chain, the angles at which the protruding portions of some of the pins are bent differ from the angles at which the protruding portions of other pins on the same side of the chain are bent.

9. A silent chain according to claim 8, in which, on each side of the chain the lengths of the protruding portions of some of the pins differ from the lengths of the protruding portions of other pins on the same side of the chain.

10. A silent chain according to claim 6, in which the protruding portions of all of said connecting pins are bent toward the inside of said closed loop.
